(19) United States
(12) Patent Application Publication
(10) Pub. No.: US 2026/0202810 A1
(43) Pub. Date: Jul. 16, 2026

(54) METHOD FOR PRODUCING A PLURALITY OF WORKPIECES, COMPUTER PROGRAM, DATA PROCESSING DEVICE AND MACHINE TOOL

(71) Applicant: TRUMPF Werkzeugmaschinen SE + Co. KG, Ditzingen (DE)

(72) Inventor: Simon Ockenfuss, Renningen (DE)

(21) Appl. No.: 19/564,245

(22) Filed: Mar. 12, 2026

Related U.S. Application Data
(63) Continuation of application No. PCT/EP2024/073450, filed on Aug. 21, 2024.

(30) Foreign Application Priority Data
Sep. 14, 2023 (DE) 10 2023 124 875.8

(51) Int. Cl. G05B 19/04

(52) U.S. Cl. CPC G05B 19/0405; G05B 2219/25294

(57) ABSTRACT

A method for producing a plurality of workpieces using a machine tool configured to produce the plurality of workpieces from a number of material sheets, the method including specifying a production sequence for producing the plurality of workpieces using the machine tool from the material sheets. The specified production sequence includes a first, second, and third production process having a first, second, and third number of production steps, respectively, for producing a respective first, second, and third number of the plurality of workpieces, and a first, second, and third sorting process respectively including removing and depositing the first, second, and third respective number of the plurality of workpieces produced by the respective first, second, and third production process. The depositing of the first, second, and third number of the plurality of workpieces is configured to be carried out at least partially simultaneously with a subsequent production process.

### CROSS REFERENCE TO RELATED APPLICATIONS

This application is a continuation of International Application No. PCT/EP2024/073450 (WO 2025/056292 A1), filed on August 21, 2024, and claims benefit to German Patent Application No. DE 10 2023 124 875.8, filed on September 14, 2023. The aforementioned applications are hereby incorporated by reference herein.

### FIELD

The invention relates to a method for producing a plurality of workpieces and a computer program, a data processing device, and a machine tool, each of which is configured to carry out the method.

### BACKGROUND

DE 102013103121 A1 discloses a method for removing workpieces from a machine tool. The workpieces are produced from a plate-like material resting on a workpiece support by cutting using a machining apparatus. After the first workpiece has been cut, a removal apparatus, which has a plurality of holding elements for each receiving a workpiece, is positioned in a receiving position to receive the first workpiece. The first workpiece is then received by the removal apparatus by means of a holding element. After receiving the first workpiece, the removal apparatus is moved from the receiving position to a waiting position outside and adjacent to the machining region of the machining apparatus. After the cutting of a further workpiece, the removal apparatus is moved from the waiting position to the receiving position and a further holding element receives the further workpiece. After receiving at least two consecutively produced workpieces or after processing of the plate-like material, the removal apparatus is moved to the unloading station.

### SUMMARY

In an embodiment, the present disclosure provides

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an oblique view of a production system for producing a plurality of workpieces by means of a machine tool;

FIG. 2 shows a further oblique view of the production system from FIG. 1;

FIG. 3 shows a schematic representation of a first workpiece to be produced using the production system;

FIG. 4 shows a schematic representation of a further second workpiece to be produced using the production system;

FIG. 5 shows a schematic representation of the temporal workflow for producing the workpieces from FIGS. 3 and 4 using the machine tool from FIG. 1;

FIG. 6 shows a schematic representation of a further temporal workflow for producing the workpieces from FIGS. 3 and 4 using the machine tool from FIG. 1;

FIG. 7 shows a schematic representation of a further temporal workflow for producing the workpieces from FIGS. 3 and 4 using the machine tool from FIG. 1;

FIG. 8 shows an oblique view of a variant of the production system from FIG. 1 with a machine tool;

FIG. 9 shows a schematic representation of sheet layouts for the production of a plurality of workpieces by means of the machine tool from FIG. 8;

FIG. 10 shows a schematic representation of a temporal workflow for producing the plurality of workpieces from FIG. 9 using the machine tool from FIG. 8;

FIG. 11 shows a schematic representation of a further temporal workflow for producing the plurality of workpieces from FIG. 9 using the machine tool from FIG. 8;

FIG. 12 shows a schematic representation of a temporal workflow for producing the plurality of workpieces according to an embodiment;

FIG. 13 shows a schematic representation of adapted sheet layouts for the production of a plurality of workpieces according to an embodiment;

FIG. 14 shows a schematic representation of a temporal workflow for producing the plurality of workpieces on the basis of the adapted sheet layouts of FIG. 13;

FIG. 15 shows a schematic representation of an adapted first sheet layout for the production of a plurality of workpieces according to an embodiment;

FIG. 16 shows a schematic representation of a temporal workflow for producing the plurality of workpieces on the basis of the adapted first sheet layout from FIG. 15;

FIG. 17 shows a schematic representation of a first sheet layout for the production of a plurality of workpieces according to an embodiment; and

FIG. 18 shows a schematic representation of a temporal workflow for producing the plurality of workpieces on the basis of the first sheet layout from FIG. 17.

### DETAILED DESCRIPTION

In an embodiment, the present disclosure provides a method for producing a plurality of workpieces, which in particular enables cost-effective production of the plurality of workpieces. In an embodiment, the present disclosure provides a computer program, a data processing device and a machine tool, each of which is configured to carry out the method.

A method according to an embodiment of the present disclosure is suitable for producing a plurality of workpieces by means of a machine tool. The machine tool is designed to produce the plurality of workpieces from a number of, for example 1, 2, 3 or 4, material sheets. The method includes the step: a) specifying a production sequence for producing the plurality of workpieces from the material sheets by means of the machine tool. The specified production sequence includes: a first production process having a number of, for example, 1, 2, 3, or 4, production steps for producing a first number of the plurality of workpieces; a first sorting process, which comprises removing and depositing the produced first number of the plurality of workpieces, wherein the depositing of the first number of the plurality of workpieces can be carried out at least partially simultaneously with a subsequent production process; a second production process having a number of, for example, 1, 2, 3, or 4, production steps for producing a second number of the plurality of workpieces; a second sorting process, which comprises removing and depositing the produced second number of the plurality of workpieces, wherein the depositing of the second number of the plurality of workpieces can be carried out at least partially simultaneously with a subsequent production process; a third production process having a number of, for example, 1, 2, 3, or 4, production steps for producing a third number of the plurality of workpieces; and a third sorting process, which comprises removing and depositing the produced third number of the plurality of workpieces, wherein the depositing of the third number of the plurality of workpieces can be carried out at least partially simultaneously with a subsequent production process. Each production process that follows a sorting process in the production sequence is carried out at least partially simultaneously with the depositing in the preceding sorting process in the production sequence. The method further includes the steps: b) determining the process duration for depositing the first number of the plurality of workpieces; c) determining the process duration of the second production process; d) if the determined process duration of step b) is longer than the determined process duration of step c): adapting the production sequence for the purpose of reducing the production duration of the plurality of workpieces and/or for the purpose of utilizing a waiting period during which no production step of the specified production sequence can be carried out and which occurs as a result of depositing the produced first number of the plurality of workpieces; and e) producing the plurality of workpieces by carrying out the production sequence by means of the machine tool.

Advantageously, this method reduces or completely avoids waiting periods during which the machine tool cannot carry out a production process. For example, the method can almost or completely prevent the second number of the plurality of produced workpieces from not being able to be removed from the machine tool after the second production process has been carried out and thus the third production process from not being able to be initiated or started, since a removal apparatus for carrying out the second sorting process is occupied with depositing the first number of the plurality of workpieces. In other words, the method ensures that the machine tool can carry out a production process almost continuously, since in particular the process durations of the sorting processes and the process durations of the production processes are coordinated. By avoiding waiting periods, the production duration for a plurality of workpieces is reduced, and the machine tool is occupied for a shorter period of time with producing the plurality of workpieces. This results in a lower cost rate for the machine tool in producing a plurality of workpieces, thus enabling cost-effective production of the plurality of workpieces.

The method can be a computer-implemented method, in particular a method carried out by a computer.

The machine tool can be designed as a punching machine, a punch laser machine, a laser cutting machine or a laser cutting system. The machine tool can have a machining apparatus, in particular in the form of a punching head and/or a laser machining head. The machine tool can be designed to produce a plurality of workpieces by cutting and/or punching a number of material sheets.

Every material sheet can be a metal sheet. In particular, the width and/or the length of a material sheet can be more than five times, in particular ten times, the thickness of the material sheet.

The plurality of workpieces can each be a punched and bent part. The plurality of workpieces can be at least three workpieces. The plurality of workpieces can be, for example, three, five, ten, twenty or more workpieces. The plurality of workpieces can all be the same or different from each other.

The production sequence can specify a sequence of processes which the machine tool carries out to produce the plurality of workpieces. The production sequence can be determined by specifying a digital model or digital models of the plurality of workpieces to be produced as well as a number of the plurality of workpieces to be produced and the dimensions of the material sheet. When determining the production sequence, the plurality of workpieces can be divided into the first number of the plurality of workpieces, the second number of the plurality of workpieces and the third number of the plurality of workpieces. In other words, the first number of the plurality of workpieces, the second number of the plurality of workpieces, and the third number of the plurality of workpieces together form the plurality of workpieces. The division of the plurality of workpieces into the first number of the plurality of workpieces, the second number of the plurality of workpieces, and the third number of the plurality of workpieces can, for example, be done in such a way that the first number, the second number, and the third number are the same.

The production sequence can be transmitted to the machine tool for the production of the plurality of workpieces. After the production sequence has been transmitted, the machine tool can produce the plurality of workpieces by carrying out the production sequence.

The production sequence can define the order in which the individual processes of the production sequence are initiated or started. In other words, the individual processes of the production sequence can be initiated or started consecutively when the production sequence is carried out by means of the machine tool. An individual process in the production sequence cannot be initiated or started before the initiation or starting of a preceding process. After initiation or starting, the initiated or started individual processes of the production sequence can be carried out at least partially simultaneously or consecutively by the machine tool.

For example, after a sorting process in the production sequence has been initiated or started, a subsequent production process in the production sequence can be initiated or started. This allows the machine tool to carry out the sorting process and the subsequent production process at least partially simultaneously.

In particular, in the production sequence, the second production process can be initiated or started after the first sorting process has been initiated or started and for the third production process to be initiated or started after the second sorting process has been initiated or started.

For example, a subsequent sorting process of the produced workpieces cannot be initiated or started before a production process in the production sequence has ended. This prevents the sorting of workpieces which have not yet been produced.

In particular, in the production sequence, it is not possible for the first sorting process to be initiated or started before the first production process has ended, for the second sorting process to be initiated or started before the second production process has ended and for the third sorting process to be initiated or started before the third production process has ended.

The production steps can comprise preparatory steps for preparing the machine tool and machining steps for machining the number of material sheets. The preparatory steps allow the machine tool to be prepared for carrying out the machining steps. A preparatory step can be, for example, replacing or changing a tool. A machining step can be, for example, punching out a hole or cutting out a contour.

In particular, a production step can be cutting or punching out a number of a plurality of workpieces from the number of material sheets. In particular, any production process can include a production step which involves cutting or punching out a number of the plurality of workpieces from a number of material sheets.

The production sequence can comprise further production processes for producing further workpieces by means of the machine tool. The further production processes can be placed completely or partially before the first production process in the production sequence. Alternatively or additionally, the further production processes in the production sequence can be completely or partially placed after the third production process.

Removing the produced number of the plurality of workpieces from a sorting process can be the removal of the produced number of the plurality of workpieces from a machining region of the machine tool. The removal of the produced number of the plurality of workpieces can be carried out by means of a removal apparatus which has a gripper for gripping the workpieces.

Removing the produced number of the plurality of workpieces can involve removing a remainder of the material sheets from which the number of the plurality of workpieces were produced. In this case, removing the produced number of the plurality of workpieces can be referred to as pallet exchange. If the removal of the produced number of the plurality of workpieces is done together with the rest of the material sheets, an unmachined material sheet can be inserted into the machine tool for the purpose of producing the remaining workpieces at the same time as the removal.

For example, the machine tool cannot carry out any production step while the produced number of the plurality of workpieces is being removed from the machining region. This prevents collisions when removing the produced number of the plurality of workpieces. In particular, this can prevent a collision between a removal apparatus, which removes the produced number of the plurality of workpieces, and the machine tool.

After removal of the produced number of the plurality of workpieces from the machining region, the number of the plurality of workpieces can be deposited. For example, the removed number of the plurality of workpieces can be deposited in a designated location, such as a pallet.

Depositing can immediately follow removal. For example, the depositing of the number of the plurality of workpieces can begin when leaving the machining region.

In other words, the machining region can divide each sorting process into a removal and a depositing of the produced number of the plurality of workpieces. The number of the plurality of workpieces can be removed if the number of the plurality of workpieces is located within the machining region. The number of the plurality of workpieces can be deposited if the removed and not yet deposited number of the plurality of workpieces is located outside the machining region.

A collision cannot occur when depositing the produced number of the plurality of workpieces, in particular since the number of the plurality of workpieces is located outside the machining region of the machine tool. In particular, no collision can occur between the removal apparatus and the machine tool during the depositing. Therefore, the depositing of the produced number of the plurality of workpieces and a subsequent production step can be carried out at least partially simultaneously.

In particular, in the production sequence, the depositing of the first number of the plurality of workpieces can be carried out at least partially simultaneously with the second production process. In particular, in the production sequence, the depositing of the second number of the plurality of workpieces can be carried out at least partially simultaneously with the third production process.

The process duration for depositing the first number of the plurality of workpieces can be determined by retrieving a stored process duration for depositing the first number of the plurality of workpieces. The stored process duration for depositing the first number of the plurality of workpieces can be ascertained by means of experiments carried out in particular before the production sequence is carried out for the purpose of ascertaining process durations. Alternatively, the process duration for depositing the first number of the plurality of workpieces can be determined by a computer-implemented simulation of the depositing of the first number of the plurality of workpieces by a removal apparatus. In particular, the process duration for depositing the first number of the plurality of workpieces can be measured in the computer-implemented simulation for depositing of the first number of the plurality of workpieces. Alternatively, the process duration for depositing the first number of the plurality of workpieces can be determined by calculating the deposit of the first number of the plurality of workpieces. In particular, the process duration for depositing the first number of the plurality of workpieces by means of a removal apparatus can be calculated.

The process duration of the second production process can be determined by retrieving a stored process duration for the second production process. The stored process duration of the second production process can be ascertained by means of experiments carried out in particular before the production sequence is carried out for the purpose of ascertaining process durations. Alternatively, the process duration of the second production process can be determined by a computer-implemented simulation of carrying out the second production process using the machine tool. In particular, the process duration of the second production process can be measured in the computer-implemented simulation of the second production process. Alternatively, the process duration of the second production process can be determined by calculating the second production process. In particular, the process duration for carrying out the second production process by means of the machine tool can be calculated.

The adapting of the production sequence can be a change in the production sequence. In particular, adapting the production sequence can involve changing the order of the production processes and/or the sorting processes. Additionally or alternatively, adapting the production sequence can involve shifting at least one production step from one production process of the production sequence to another production process of the production sequence.

Adapting the production sequence to reduce the production duration of the plurality of workpieces can, for example, comprise the following steps: determining a first production duration for carrying out the specified production sequence by means of the machine tool, generating a modified production sequence by changing the specified production sequence, determining the second production duration for carrying out the modified production sequence by means of the machine tool, and replacing the specified production sequence with the modified production sequence if a value of the first production duration is greater than a value of the second production duration.

The production duration of a production sequence can be determined by a computer-implemented simulation of carrying out the production sequence by means of the machine tool. In particular, the production duration can be measured in the computer-implemented simulation of carrying out the production sequence by means of the machine tool. Alternatively, the production duration of a production sequence can be determined by calculating the production sequence carried out by means of the machine tool.

The production of the plurality of workpieces by carrying out the production sequence by means of the machine tool can be the carrying out of the individual processes of the production sequence by the machine tool.

In an embodiment of the method, the adapting of the production sequence of step d) includes the step: d1) shifting a number of production steps from the first production process and/or shifting a number of production steps from the third production process to the second production process. A value for the process duration of the number of production steps shifted in step d1) is greater than or equal to a value for the difference calculated by subtracting the process duration determined in step c) from the process duration determined in step b).

By shifting the production steps, the number of production steps in the second production process can increase, thereby increasing the process duration of the second production process. This prevents the depositing of the first number of the plurality of workpieces from taking longer than the second production process. In particular, this can prevent waiting periods for the machine tool.

By shifting the number of production steps from the first production process to the second production process, the value of the first number of the plurality of workpieces in the first production process can decrease, and the value of the second number of the plurality of workpieces in the second production process can increase.

By shifting the number of production steps from the third production process to the second production process, the value of the third number of the plurality of workpieces in the third production process can decrease, and the value of the second number of the plurality of workpieces in the second production process can increase.

After the shifting, the difference calculated by subtracting the process duration for the second production process from the process duration for the depositing of the first number of the plurality of workpieces can be zero or negative.

For example, the first number of the plurality of workpieces, the second number of the plurality of workpieces, the third number of the plurality of workpieces and the number of material sheets can each be one. In other words, the plurality of workpieces can be three workpieces that are cut out consecutively from a material sheet. A first workpiece of the three workpieces can be produced by cutting it out of the material sheet, which is why the first production process includes the production step of cutting out from the material sheet. A second workpiece of the three workpieces can be produced by making a hole and cutting out from the material sheet, which is why the second production process includes the production steps of making the hole and cutting out from the material sheet. A third workpiece of the three workpieces can be produced by making two holes and cutting out from the material sheet, which is why the third production process includes the production steps of making the hole, making the further hole and cutting out from the material sheet. Shifting the number of production steps from the third production process to the second production process of step d1) can, for example, be a shift of the production step of making the further hole. This allows the hole of the third workpiece to be made in the second production process already, while the first workpiece is being deposited.

For example, the first number of the plurality of workpieces, the second number of the plurality of workpieces and the third number of the plurality of workpieces can each be five. The number of material sheets can be three. The first five workpieces can be produced by cutting out from a first of the three material sheets, which is why the first production process includes the production step of cutting out from the material sheet five times. The second five workpieces can be produced by cutting out from a second material sheet of the three material sheets, which is why the second production process includes the production step of cutting out from the material sheet five times. The third five workpieces can be produced by cutting out from a third material sheet of the three material sheets, which is why the third production process includes the production step of cutting out from the material sheet five times. Shifting the number of production steps from the first production process to the second production process of step d1) can, for example, be a shifting of one of the five operations of cutting out from the material sheet. This means that the first production process can include the production step of cutting out from the material sheet four times and the second production process can include the production step of cutting out from the material sheet six times. This allows the first number of the plurality of workpieces to be reduced by one and the second number of the plurality of workpieces to be increased by one.

In an embodiment of the method, the machine tool has a first removal apparatus and a second removal apparatus. The production sequence involves carrying out the first sorting process and the second sorting process by means of the first removal apparatus. The production sequence involves carrying out the third sorting process by means of the second removal apparatus. One production step of the second production process brings about a separating of the second number of the plurality of workpieces from the material sheet by means of the machine tool. The adapting of the production sequence of step d) includes the step: d2) shifting the production step of the second production process, which brings about the separating of the second number of the plurality of workpieces from the material sheet, and the second sorting process after the third sorting process. In other words, the order of the production sequence is changed by step d2) such that the production step of the second production process, which brings about the separating of the second number of the plurality of workpieces from the material sheet, and the second sorting process are provided after the third sorting process.

Step d2) advantageously allows the order of the production sequence to be changed such that the first removal apparatus and the second removal apparatus alternately carry out a sorting process. This allows each removal apparatus more time to carry out a sorting process.

The first and second removal apparatuses can carry out a sorting process independently of each other.

The first removal apparatus can have a gripper for gripping the workpieces. The gripper can have a suction gripper, in particular a vacuum suction gripper and/or a magnetic gripper. Removal of the workpieces by the first removal apparatus can comprise gripping the workpieces using the gripper.

The second removal apparatus can have a flap and a removal hole, wherein the flap closes the removal hole in a closed position and opens the removal hole in an open position. Removal of the workpieces by the second removal apparatus can comprise ejecting the workpieces from the machine tool through the removal hole by means of transferring the flap into the open position. Alternatively, the second removal apparatus can have a further gripper for gripping the workpieces. The further gripper can have a suction gripper, in particular a vacuum suction gripper and/or a magnetic gripper. Removing the workpieces by the second removal apparatus can comprise gripping the workpieces using the further gripper.

Step d2) can be equivalent to shifting the third production process and the third sorting process before the second production process, which brings about the separating of the second number of the plurality of workpieces from the material sheet.

In an embodiment of the method, the production steps of the first production process bring about the production of the first number of the plurality of workpieces from a first material sheet on the basis of a first sheet layout. The removal in the first sorting process comprises the removal of the first material sheet in the form of a first scrap skeleton together with the first number of the plurality of workpieces produced. The production steps of the second production process bring about the production of the second number of the plurality of workpieces from a second material sheet on the basis of a second sheet layout. The removal of the second sorting process comprises the removal of the second material sheet in the form of a second scrap skeleton together with the produced second number of the plurality of workpieces. The production steps of the third production process bring about the production of the third number of the plurality of workpieces from a third material sheet on the basis of a third sheet layout. The removal of the third sorting process comprises the removal of the third material sheet in the form of a third scrap skeleton together with the produced third number of the plurality of workpieces. The process duration of step b) also comprises the depositing of the first scrap skeleton.

Determining the process duration of step b) can be described as determining the process duration for depositing the first number of the plurality of workpieces and depositing the first scrap skeleton.

The removal of the produced workpieces can be in the form of a pallet exchange. During removal of the produced workpieces, a material sheet to be subsequently machined can be inserted into the machine tool at the same time.

After removal, the produced workpieces and the scrap skeleton can lie in a buffer region. The produced workpieces and the scrap skeleton can be manually deposited from the buffer region by one or more people and/or mechanically using a gripper. During the depositing, the buffer region can be occupied by the produced workpieces and/or by the scrap skeleton, so that no subsequently produced workpieces with scrap skeleton can be removed from the machine tool.

The first sheet layout can be described as nesting of the first number of the plurality of workpieces. The first sheet layout can specify a space-saving arrangement for producing the first number of the plurality of workpieces from the first material sheet. The second sheet layout can be described as nesting of the second number of the plurality of workpieces. The second sheet layout can provide a space-saving arrangement for producing the second number of the plurality of workpieces from the second material sheet. The third sheet layout can be described as nesting of the third number of the plurality of workpieces. The third sheet layout can provide a space-saving arrangement for producing the third number of the plurality of workpieces from the third material sheet. The first sheet layout, the second sheet layout, and the third sheet layout can be predetermined.

In an embodiment of the method, the adapting of the production sequence of step d) includes the step: d3) shifting the first production process and the first sorting process after the second sorting process, in particular if a value of a determined production duration for the plurality of workpieces by means of the production sequence before the shifting of the first production process and the first sorting process is greater than a value of a determined production duration for the plurality of workpieces by means of the production sequence after the shifting of the first production process and the first sorting process; or d4) shifting the third production process and the third sorting process after the first sorting process, in particular if a value of a determined production duration for the plurality of workpieces by means of the production sequence before the shifting of the first production process and the first sorting process is greater than a value of a determined production duration for the plurality of workpieces by means of the production sequence after the shifting of the third production process and the third sorting process.

For example, step d3) can be carried out if the value of a difference calculated by subtracting the process duration determined in step c) from the process duration determined in step b) is greater than the value of a difference calculated by subtracting the process duration of the third production process from the process duration determined in step b).

For example, step d4) can be carried out if the value of a difference calculated by subtracting the process duration determined in step c) from the process duration determined in step b) is greater than the value of a difference calculated by subtracting the process duration determined in step c) from a process duration of the third production process.

In an embodiment of the method, the adapting of the production sequence of step d) includes the step: d5) changing the first sheet layout, the second sheet layout and/or the third sheet layout, in particular if a value of a determined production duration for the plurality of workpieces by means of the production sequence before the changing of the first sheet layout, the second sheet layout and/or the third sheet layout is greater than a value of a determined production duration for the plurality of workpieces by means of the production sequence after the changing of the first sheet layout, the second sheet layout and/or the third sheet layout.

Changing the sheet layouts can change the number of the plurality of workpieces that can be produced from one material sheet. For example, the sheet layout can be changed so that the process duration of the second production process is equal to or greater than the process duration for depositing the first number of the plurality of workpieces and the scrap skeleton. For example, the sheet layouts can be changed in such a way that the difference between the process durations of the production processes after the changing of the sheet layout is less than before the changing of the sheet layouts.

In an embodiment of the method, the adapting of the production sequence of step d) includes the step: d6) adapting the production steps of the first production process such that the production steps of the first production process bring about a production of at least two adjacent workpieces in the first sheet layout with at least one connecting element for jointly depositing the adjacent workpieces.

By jointly depositing adjacent workpieces, the process duration for depositing the first number of the plurality of workpieces can be advantageously reduced. The adjacent workpieces connected to one another by the connecting element can be separated from each other when or after being deposited; for example, the adjacent workpieces can be separated from each other by breaking the connecting element.

The connecting element can be referred to as a connecting bridge. The connecting element can be designed as a nanojoint or a microjoint. The connecting element can form at least one holding point where the adjacent workpieces are not completely separated from each other.

In an embodiment of the method, the adapting of the production sequence of step d) includes the step: d7) changing a process parameter of at least one production step of the second production process for the purpose of increasing the process duration of the second production process.

In particular, the process parameter can be changed in such a way as to increase the process duration of the second production process. By increasing the process duration of the second production process, a waiting period for the machine tool, which occurs between the first production process and the removal of the second number of the plurality of workpieces, can be advantageously avoided. Increasing the process duration of the second production process can save energy and/or achieve a higher quality of the produced workpieces.

The process parameter of the production step of the second production process can be changed in such a way that the process duration of the second production process increases by at least one value equal to a difference value calculated by subtracting the process duration determined in step c) from the process duration determined in step b).

For example, the process parameter could be a cutting parameter for cutting out the workpieces from the number of material sheets. The cutting parameter can be changed so as to increase the duration of cutting out the workpieces while improving the quality of the produced cut edge. The cutting parameter can be a focus diameter, a laser power, a nozzle focus distance, a nozzle workpiece distance, a feed rate, a gas pressure, a nozzle diameter or a gas type.

In an embodiment of the method, the adapting of the production sequence of step d) includes the step: d8) inserting an energy-saving process before or after the second production process, which brings about an energy-saving mode of at least one device of the machine tool that is not required for depositing the first number of the plurality of workpieces. The process duration of the energy-saving process is equal to the difference calculated by subtracting the process duration determined in step c) from the process duration determined in step b).

Energy can be advantageously reduced by the energy-saving process. The device not required for depositing could, for example, be a laser apparatus for generating a laser beam for cutting the number of material sheets.

A computer program according to an embodiment of the present disclosure comprises commands which, when the computer program is executed by a computer, cause it to carry out a method described above. The computer program can, for example, be stored on a data carrier. The data carrier can be a hard drive, a memory card or a USB mass storage device.

The specified production sequence can be stored on the computer, in particular on the data carrier, or in a memory of the machine tool. If the specified production sequence is stored on the computer, the production sequence can be transmitted to the machine tool after the method has been carried out. If the specified production sequence is stored in the memory of the machine tool, the computer can access the memory of the machine tool via a data connection and carry out the method for the production sequence stored in the memory of the machine tool.

A data processing device according to an embodiment of the present disclosure is configured to carry out a method described above. The device can be designed as a computer, cloud computer, or control apparatus.

A machine tool according to an embodiment of the present disclosure is designed to carry out a method described above. In particular, the machine tool can have a control apparatus which is configured to carry out the method described above.

A production system according to an embodiment of the present disclosure has a production controller which is designed to carry out a method described above. Furthermore, the production system has the machine tool, which is designed to produce a plurality of workpieces from a number of material sheets.

Further advantages and advantageous embodiments of the present disclosure can be derived from the figures and the description thereof. All features disclosed in the figures and the description thereof can be essential both on their own and in any desired combination with one another.

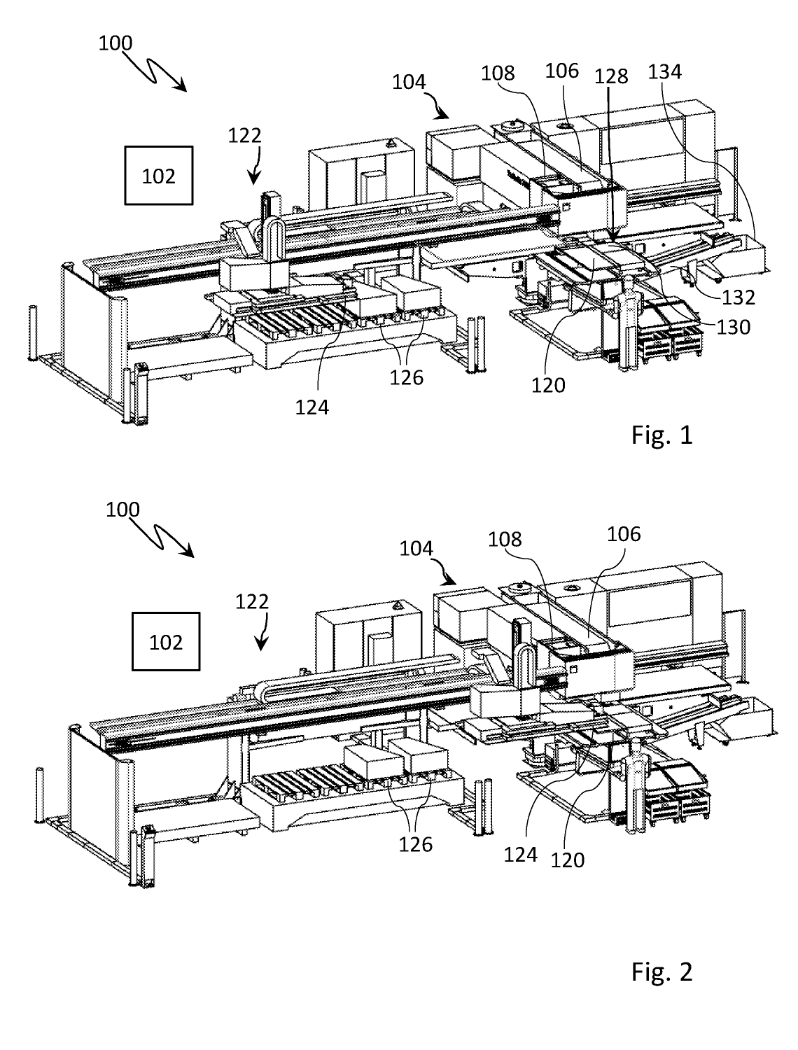

FIG. 1 shows a production system 100 having a production controller 102 and a machine tool 104. The machine tool 104 is designed to produce a plurality of workpieces from a number of material sheets in the form of metal sheets.

The machine tool 104 is a punch laser machine. In this case, the punch laser machine 104 combines advantages of punch machining with advantages of laser machining. The machine tool 104 therefore has a punching device 106 having a punching head and a laser device 108 having a laser machining head.

A workpiece can be produced by means of the punching device 106 and/or the laser device 108. For this purpose, the material sheets are machined, in particular punched or cut, by means of the punching head and/or the laser machining head.

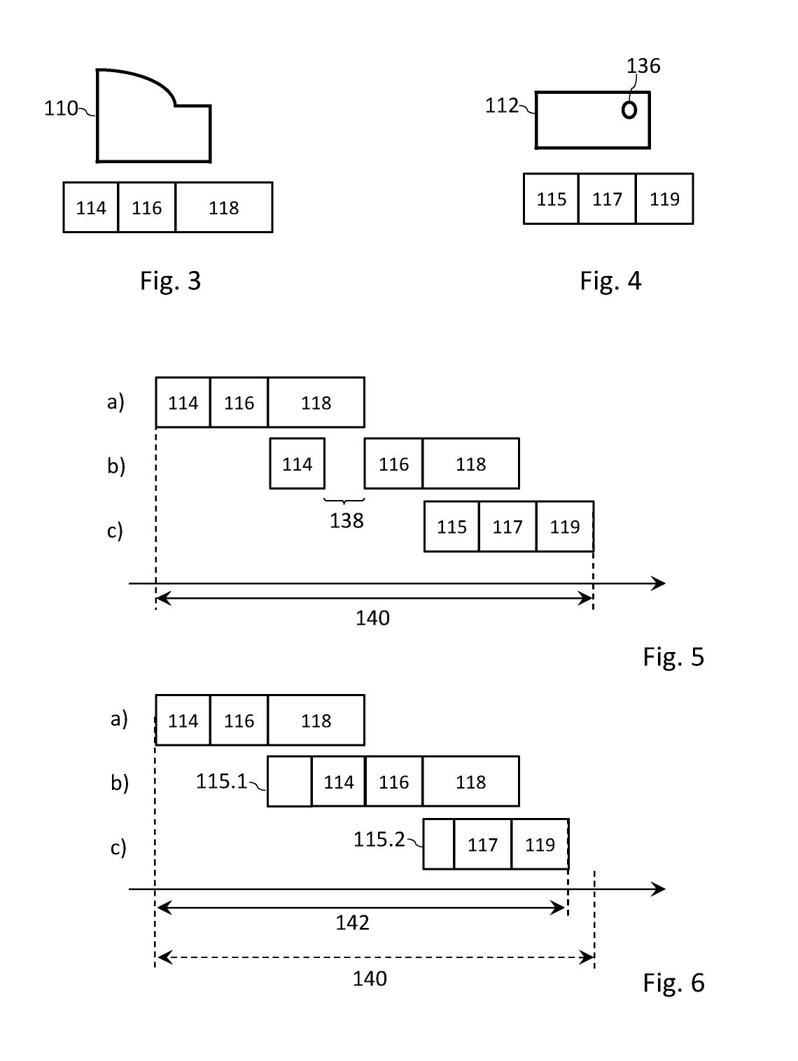

The machine tool 104 is to be used to produce a first workpiece 110 twice and a second workpiece 112 once. The first workpiece 110 is shown in FIG. 3 above and the second workpiece 112 is shown in FIG. 4 above.

FIGS. 3 and 4 below show a schematic representation of the workflow that the machine tool 104 carries out to produce one of the workpieces 110, 112. The two workflows each comprise a production workflow 114, 115, a removal 116, 117 of the produced workpiece 110, 112 and a depositing 118, 119 of the produced workpiece 110, 112.

The lengths of the production workflow 114, 115, removal 116, 117 or depositing 118, 119 shown below in FIGS. 3 and 4 are representative of the durations of the respective processes. FIGS. 3 and 4 show below that the depositing 118 of the first workpiece 110 takes longer than the depositing 119 of the second workpiece 112.

FIG. 1 shows that the machine tool 104 has a tool table 120 on which a produced workpiece rests after production. If the produced workpiece is a first workpiece 110, the produced first workpiece 110 is removed from the machine tool 104 and deposited by means of a first removal apparatus 122 arranged next to the machine tool 104. In other words, the production workflow 114 is carried out by means of the machine tool 104, and the removal 116 and the depositing 118 are carried out by means of the first removal apparatus 122.

The first removal apparatus 122 has a gripper 124 for gripping the workpieces. FIG. 2 shows the first removal apparatus 122 during removal 116 of a produced workpiece. The produced workpiece is removed from a machining region of the machine tool 104 by means of the first removal apparatus 122. During the removal 116 of the workpiece from the machining region, the machine tool 104 cannot carry out a production step. This prevents a collision between the machine tool 104 and the first removal apparatus 122 during removal 116. The removal 116 is completed when the first removal apparatus 122 has left the machining region together with the workpiece.

The removal 116, 117 is immediately followed by the depositing 118, 119 of the produced workpiece. In the example shown in FIG. 1, the first workpieces 110 are deposited on pallets 126 by the first removal apparatus 122.

If the produced workpiece is a second workpiece 112, the produced second workpiece 112 is removed from the machine tool 104 by a second removal apparatus 128 and deposited.

The second removal apparatus 128 has a flap 130 which closes a hole in the tool table 120.When the second workpiece 112 has been produced, the machine tool 104 positions the second workpiece 112 on the flap 130, which then opens. The second workpiece 112 falls through the hole onto a conveyor belt 132 of the second removal apparatus 128.In other words, the second workpiece 112 is ejected from the machining region of the machine tool 104 through the flap 130.Therefore, removal 117 of the second workpiece 112 comprises positioning the second workpiece 112 on the flap 130 and ejecting the second workpiece 112.During the removal 117 of the second workpiece 112, the machine tool cannot carry out a production step.

The conveyor belt 132 then transports the removed second workpiece 112 into a container 134 of the second removal apparatus 128. Therefore, depositing 119 of the second workpiece 112 comprises transporting the second workpiece 112 into the container 134.

When depositing 118, 119 of the first workpiece 110 or the second workpiece 112 is carried out, no collision can occur. Therefore, the depositing 118, 119 of the produced workpieces and a production workflow 114, 115 following the depositing 118, 119 can be carried out at least partially simultaneously.

In order to produce the two first workpieces 110 and the second workpiece 112 from material sheets by means of the machine tool 104, a production sequence is specified to the production controller 102.The production sequence has a first production process for producing the first of the two first workpieces 110, which comprises the production workflow 114.The first production process comprises the production step "cutting out a first workpiece 110 from the material sheet" in the production workflow 114.This is followed by a first sorting process, which comprises the removal 116 and the depositing 118 of the produced first workpiece 110 by means of the first removal apparatus 122.Simultaneously with the depositing 118 of the produced first workpiece 110, the production sequence provides for a second production process to be carried out to produce the second of the two first workpieces 110, which comprises the production workflow114.The second production process includes the production step "cutting out a first workpiece 110 from the material sheet" in the production workflow 114.This is followed by a second sorting process, which comprises the removal 116 and the depositing 118 of the produced first workpiece 110 by means of the first removal apparatus 122.Simultaneously with the depositing 118 of the produced first workpiece 110, the production sequence provides for a third production process to be carried out for producing the second workpiece 112, which comprises the production workflow 115.The third production process includes the production steps "115.1 producing a hole 136" and "115.2 cutting out a second workpiece 112 from the material sheet" in the production workflow 115.This is followed by a third sorting process, which comprises the removal 117 and the depositing 119 of the produced second workpiece 112 by means of the second removal apparatus 128.

If the machine tool 104 produces the two first workpieces 110 and the second workpiece 112 by means of consecutive completion of the individual processes of the production sequence, this would result in the temporal workflow shown in FIG. 5. FIG. 5 a) shows the workflow for producing the first of the two first workpieces 110; FIG. 5 b) shows the workflow for producing the second of the two first workpieces 110; and FIG. 5 c) shows the sequence for producing the second workpiece 112.

In FIG. 5 b) it can be seen that between the production process of the second of the two first workpieces 110 and the removal 116, a waiting period 138 occurs in which the produced second of the two first workpieces 110 lies on the tool table 120 and cannot be sorted out of the machine tool 110, since the first removal apparatus 122 is occupied with the depositing 118 of the first of the two first workpieces 110. It is also not possible to carry out the third production process, since the second of the two first workpieces 110 has not yet been removed. Therefore, a production duration of 140 for the two first workpieces 110 and the second workpiece 112 includes the waiting period 138.

In order to shorten the production duration 140, the production controller 102 carries out a method to reduce or completely avoid the waiting period 138 before production of the workpieces 110, 112. In the exemplary embodiment shown in FIGS. 1 to 7, the production controller 102 is designed as a computer and the method is a computer-implemented method.

The method includes the step: b) determining the process duration for depositing 118 of the first of the two first workpieces 110. The process duration is determined by a computer-implemented simulation of the depositing 118 of the first of the two first workpieces 110.

The method includes the step: c) determining the process duration of the production process of the second of the two first workpieces 110. The process duration is determined by a computer-implemented simulation of the production process of the second of the two first workpieces 110.

Since the determined process duration of step b) is longer than the determined process duration of step c), the production controller 102 carries out the step: d) adapting the production sequence for the purpose of reducing the production duration 140 of the workpieces 110, 112.

The adapting of the production sequence in step d) is carried out by the step: d1) shifting the production step "115.1 producing a hole 136" from the third production process to the second production process. This means that, when the production sequence is carried out, the production workflow 114 is carried out fully and the production process 115 is carried out partially in the second production process. In other words, the second of the two first workpieces 110 is produced together with the hole 136 in the second workpiece 112.

By shifting the production step "115.1 producing a hole 136", the number of production steps in the second production process increases and the number of production steps in the third production process decreases. Since the value of the process duration of the production step "115.1 producing a hole 136", which is shifted in step d1), is equal to the waiting period 138, the waiting period 138 is completely avoided.

The workflow for the adapted production sequence is shown in FIG. 6. A production duration 142 of the adapted production sequence is shorter than the production duration 140 of the specified production sequence. For better comparison, the production duration 140 of the specified production sequence is additionally shown as a dashed line in FIG. 6.

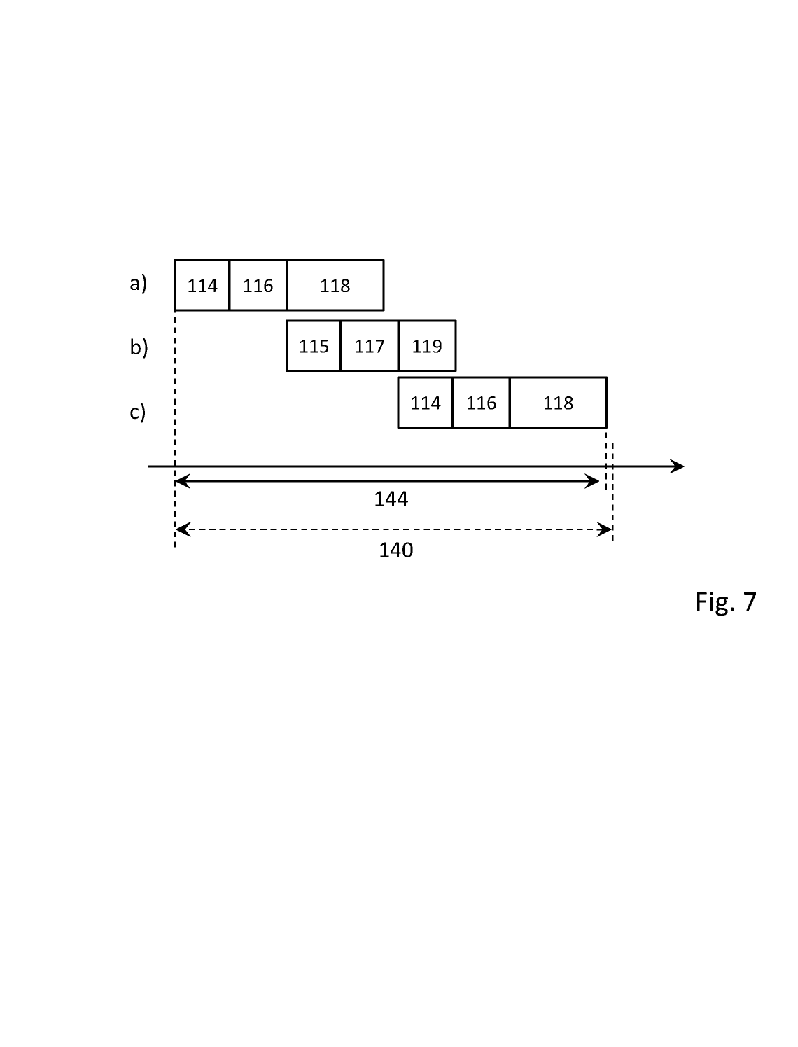

Furthermore, the production controller 102 adapts the specified production sequence by a step d2): d2) shifting the production step "cutting out a first workpiece 110 from the material sheet" of the second production process and the second sorting process after the third sorting process. This changes the order of the production sequence such that initially the first of the two first workpieces 110 is produced, then the second workpiece 112 and then the second of the two first workpieces 110.The adapted production sequence is shown in FIG. 7.

Since the first workpieces 110 are removed by means of the first removal apparatus 122 and the second workpiece 112 is removed by means of the second removal apparatus 128, the depositing 118 of a first workpiece 110 can take place at least partially simultaneously with the removal 117 of a second workpiece 112 and the depositing 119 of a second workpiece 112 can take place at least partially simultaneously with the removal 116 of a first workpiece 110.

A production duration 144 of the adapted production sequence of FIG. 7 is shorter than the production duration 140 of the specified production sequence. For better comparison, the production duration 140 of the specified production sequence is additionally shown as a dashed line in FIG. 7.

The production controller 102 is designed to compare the production duration 142 of FIG. 6 with the production duration 144 of FIG. 7 and to replace the specified production sequence with the adapted production sequence, which has a shorter production duration 142, 144. In the illustrated exemplary embodiment of FIGS. 6 and 7, a value of the production duration 142 of FIG. 6 is smaller than a value of the production duration 144 of FIG. 7, which is why the production controller 102 replaces the specified production sequence with the adapted production sequence of FIG. 6.

The method includes the step: e) producing the workpieces 110, 112 by carrying out the production sequence by means of the machine tool 104. For this purpose, the production controller 102 transmits the production sequence of FIG. 6 to the machine tool 104, which then carries out the transmitted production sequence and thereby produces the workpieces 110, 112

In a further exemplary embodiment, step d1) and step d2) can be carried out consecutively. For example, the production step of the second production process, which brings about the separation of the second number of the plurality of workpieces from the material sheet, and the second sorting process can be shifted after the third sorting process, and subsequently a number of production steps from the first production process and/or a number of production steps from the third production process can be shifted to the second production process.

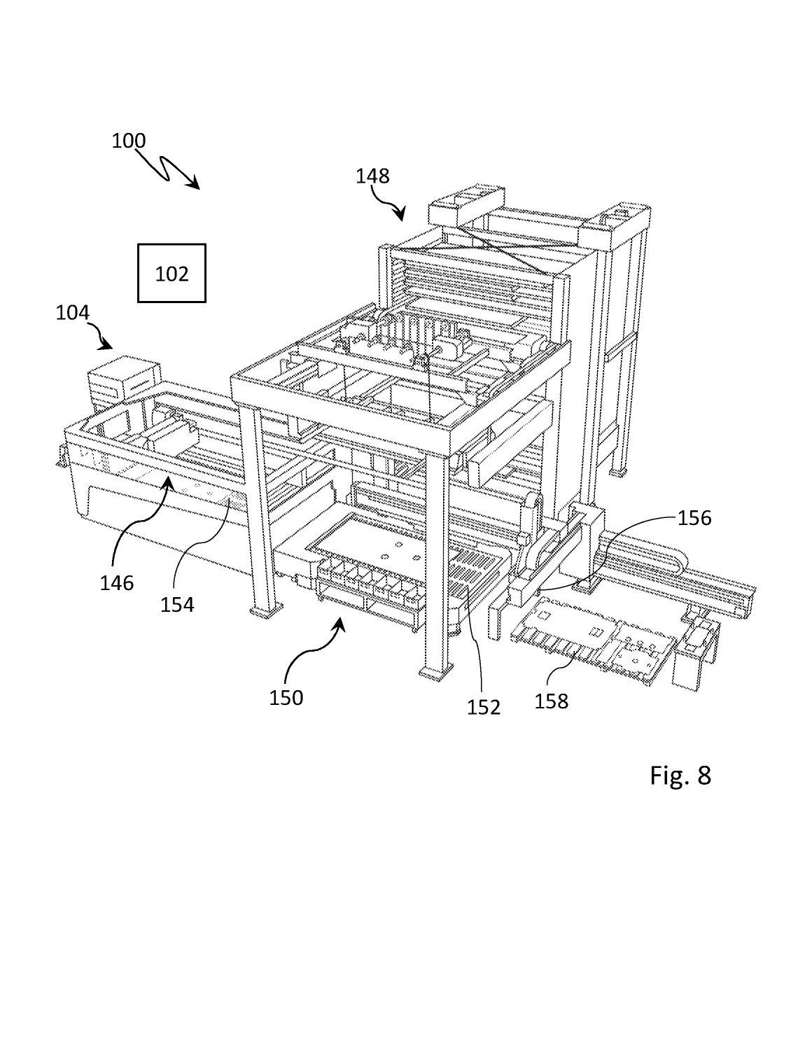

FIG. 8 shows a further exemplary embodiment of the production system 100 described by FIGS. 1 to 7, wherein the same reference signs are used for identical and functionally equivalent elements and, in this respect, reference can be made to the statements given above in relation to FIGS. 1 to 7, with the result that substantially only the present differences are discussed.

The machine tool 104 shown in FIG. 8 is a laser cutting system with a machining space 146, which includes the machining region of the machine tool 104. The production system 100 has a material store 148 and a buffer region 150 located between the material store 148 and the machining space 146.

The material store 148 stores material sheets from which the machine tool 104 produces workpieces.

Workpieces are produced by means of the machine tool 104 by removing a material sheet from the material store 148 and depositing the removed material sheet on a first pallet 152, which is placed in the buffer region 150. Subsequently, a pallet exchange takes place with a second pallet 154, which is placed in the machining space 146. The pallet exchange involves removing the second pallet 154 from the machining space 146 and introducing the first pallet 152 together with the material sheet into the machining space 146. During the pallet exchange, the machine tool 104 cannot carry out a production step. After the pallet exchange, the machine tool 104 can produce workpieces by machining the material sheet.

If the machine tool 104 has already produced workpieces from a material sheet before the pallet exchange, these lie on the second pallet 154 in the buffer region 150 together with a scrap skeleton after the pallet exchange. A gripper 156 of the production system 100 deposits the produced workpieces and the scrap skeleton, with the produced workpieces being deposited on a pallet 158.

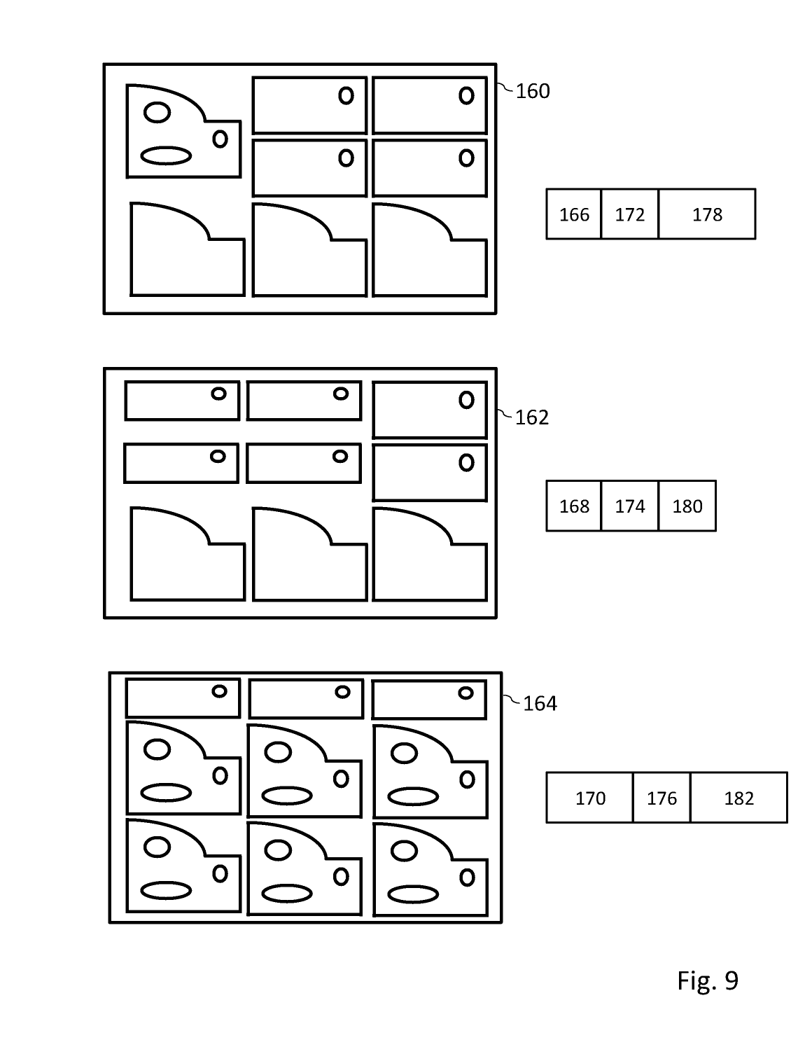

The machine tool 104 is intended to be used to produce a first number of the plurality of workpieces from a first material sheet 160, a second number of the plurality of workpieces from a second material sheet 162 and a third number of the plurality of workpieces from a third material sheet 164. The material sheets 160, 162, 164 and their respective specified sheet layouts are shown schematically on the left in FIG. 9. This shows that the first number of the plurality of workpieces is eight, the second number of the plurality of workpieces is nine, and the third number of the plurality of workpieces is nine. In other words, a total of 26 workpieces are to be produced.

FIG. 9, on the right, shows the schematic workflows which are associated with respective material sheets 160, 162, 164 and which the machine tool 104 carries out to produce the workpieces. The two workflows each comprise a production workflow 166, 168, 170, a removal 172, 174, 176 of the produced workpieces and a depositing 178, 180, 182 of the produced workpieces and the scrap skeleton.

The lengths of the production workflow 166, 168, 170, removal 172, 174, 176 and depositing 178, 180, 182 shown on the right in FIG. 9 are representative of the durations of the respective processes.

The removal 172, 174, 176 is carried out by pallet exchange. The pallet exchange is independent of the number or complexity of produced workpieces, which is why the duration for the removal 172, 174, 176 of the material sheets 160, 162, 164 is the same. The duration of the production workflow 166, 168, 170 depends on the number and complexity of the workpieces to be produced from the associated material sheet 160, 162, 164, which is why the durations of the production workflows 166, 168, 170 differ from each other. The duration for depositing 178, 180, 182 depends on how many workpieces are to be deposited by means of the gripper 156 and what distances the gripper 156 has to travel to deposit a workpiece, which is why the durations for depositing 178, 180, 182 are different from each other.

In order to produce the workpieces from the material sheets 160, 162, 164 by means of the machine tool 104, a production sequence and the sheet layouts shown in FIG. 9 are specified to the production controller 102. The production sequence has a first production process for producing the first number of the plurality of workpieces, which comprises the production workflow 166. This is followed by a first sorting process, which comprises the removal 172 and the depositing 178 of the produced first number of the plurality of workpieces. Simultaneously with the depositing 178 of the produced first number of the plurality of workpieces, the production sequence provides for a second production process to be carried out to produce the second number of the plurality of workpieces, which comprises the production workflow 168. This is followed by a second sorting process, which comprises the removal 174 and the depositing 180 of the produced second number of the plurality of workpieces. Simultaneously with the depositing 180, the production sequence provides for a third production process to be carried out to produce the third number of the plurality of workpieces, which comprises the production workflow 170. This is followed by a third sorting process, which comprises the removal 176 and the depositing 182.

The first production process brings about the production of the first number of the plurality of workpieces from the first material sheet 160 on the basis of the first sheet layout. The removal 172 in the first sorting process comprises the removal of the first material sheet 160 in the form of a first scrap skeleton together with the produced first number of the plurality of workpieces, and the depositing 178 in the first sorting process comprises the depositing of the first scrap skeleton. The second production process brings about the production of the second number of the plurality of workpieces from a second material sheet 162 on the basis of the second sheet layout. The removal 174 in the second sorting process comprises the removal of the second material sheet 162 in the form of a second scrap skeleton together with the produced second number of the plurality of workpieces, and the depositing 180 in the second sorting process comprises the depositing of the second scrap skeleton. The third production process brings about the production of the third number of the plurality of workpieces from a third material sheet 164 on the basis of the third sheet layout. The removal 176 in the third sorting process comprises the removal of the third material sheet 164 in the form of a third scrap skeleton together with the produced third number of the plurality of workpieces, and the depositing 182 in the third sorting process comprises the depositing of the third scrap skeleton.

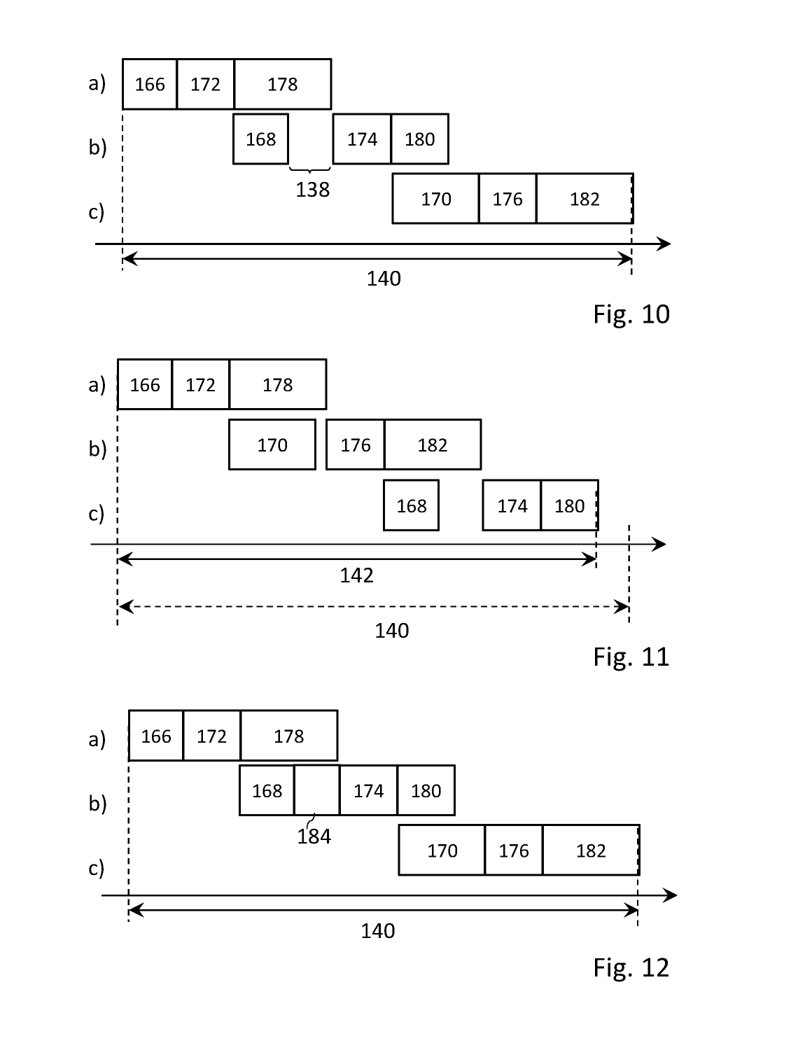

If the machine tool 104 produces the workpieces by consecutive completion of the individual processes of the production sequence, this would result in the temporal workflow shown in FIG. 10. FIG. 10 a) shows the workflow for producing the first number of the plurality of workpieces, FIG. 10 b) shows the workflow for producing the second number of the plurality of workpieces, and FIG. 10 c) shows the workflow for producing the third number of the plurality of workpieces.

FIG. 10 b) shows that between the production workflow 168 and the removal 174 a waiting period 138 occurs, during which the produced second number of the plurality of workpieces lie on the pallet within the machining space 146. The removal 174 of the second number of the plurality of workpieces from the machining space 146 is not possible because the buffer region 150 is occupied by the first number of the plurality of workpieces which have not yet been completely sorted. Therefore, a production duration 140 for the plurality of workpieces includes a waiting period 138.

In order to shorten the production duration 140, the production controller 102 carries out a method to reduce or completely avoid the waiting period 138 before production of the plurality of workpieces.

The method includes the step: b) determining the process duration for depositing 178 the first number of the plurality of workpieces and the first scrap skeleton. The process duration is determined by a computer-implemented simulation for the depositing 178 of the first number of the plurality of workpieces and the first scrap skeleton.

The method includes the step: c) determining the process duration of the second production process. The process duration is determined by a computer-implemented simulation of the second production process.

Since the determined process duration in step b) is longer than the determined process duration of step c), the production controller 102 carries out the step: d) adapting the production sequence for the purpose of reducing the production duration 140 of the plurality of workpieces.

The adapting of the production sequence in step d) is carried out by step: d4) shifting the third production process and the third sorting process after the first sorting process.

The adapted production sequence is shown in FIG. 11. The production duration 142 of the adapted production sequence is shorter than the production duration 140 of the specified production sequence. For better comparison, the production duration 140 of the specified production sequence is additionally shown as a dashed line in FIG. 11. The production controller 102 is designed to compare the production duration 140 with the production duration 142 and to replace the specified production sequence with the adapted production sequence, since the adapted production sequence has a shorter production duration 142.

The method includes the step: e) producing the plurality of workpieces by carrying out the production sequence by means of the machine tool 104. For this purpose, the production controller 102 transmits the production sequence of FIG. 11 to the machine tool 104, which then carries out the transmitted production sequence and thereby produces a plurality of workpieces.

FIG. 12 shows a schematic representation of a temporal workflow of a further exemplary embodiment of the production system 100 described by FIGS. 8 to 11, in which the same reference signs are used for identical and functionally equivalent elements and, in this respect, reference can be made to the above statements relating to FIGS. 8 to 11, with the result that substantially only the present differences are discussed.

The production controller 102 carries out the method for the purpose of utilizing the waiting period 138 before production of the plurality of workpieces. For this purpose, the production sequence is adapted, instead of step d4), by the step: d8) inserting an energy-saving process 184 of the machine tool 104 between the production workflow 170 and the removal 174.

The process duration of the energy-saving process 184 is equal to a difference calculated by subtracting the process duration determined in step c) from the process duration determined in step b).

The energy-saving process 184 utilizes the waiting period 138 by saving energy. The production duration 140 remains unchanged.

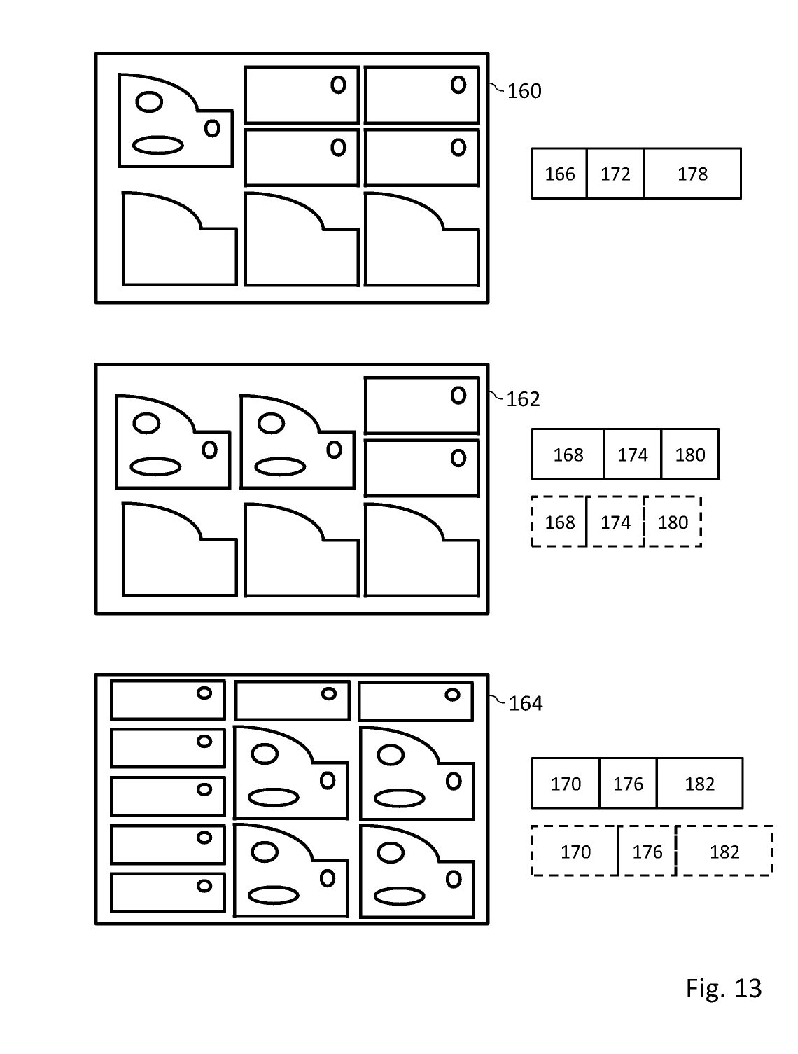

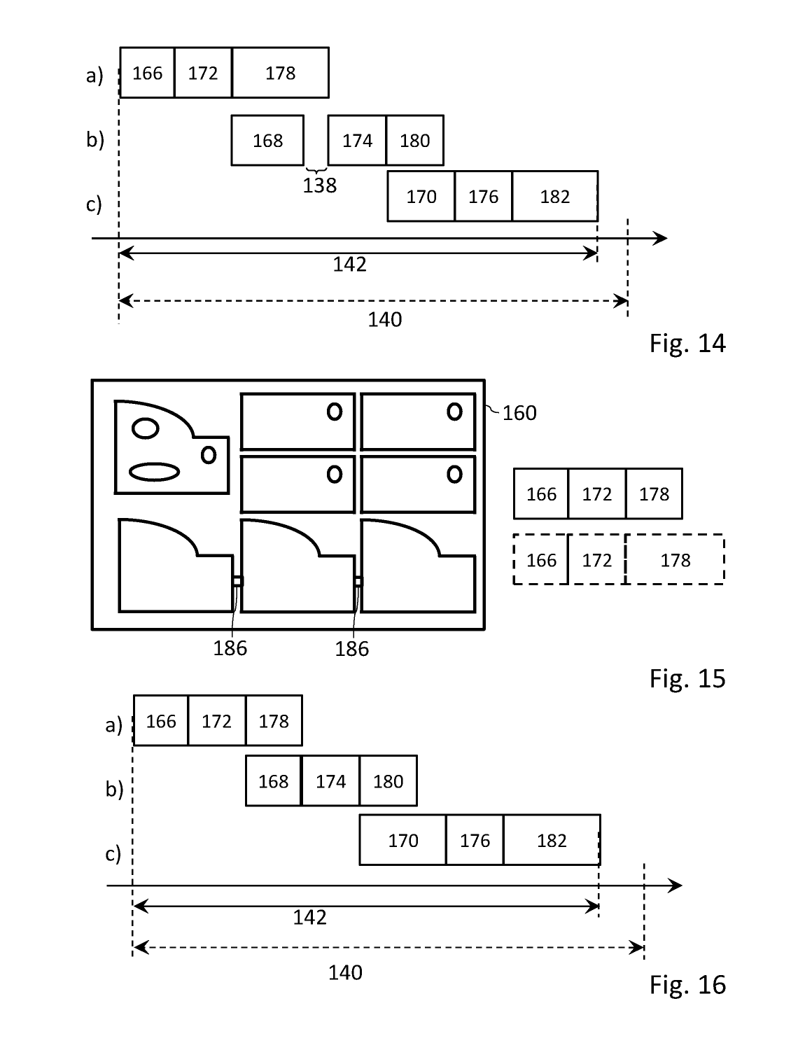

FIGS. 13 and 14 show adapted sheet layouts of a further exemplary embodiment and a temporal workflow for producing the plurality of workpieces on the basis of the adapted sheet layouts of FIG. 13, in which the same reference signs are used for identical and functionally equivalent elements and, in this respect, reference can be made to the above statements relating to FIGS. 8 to 11, so that substantially only the present differences are discussed.

The production sequence is adapted, instead of step d4), by step: d5) changing the second sheet layout and the third sheet layout.

The production controller 102 is designed to determine the duration for producing individual workpieces of the sheet layouts.

In the exemplary embodiment shown in FIGS. 13 and 14, the production controller 102 determines the duration for the production of individual workpieces of the third sheet layout and the duration for the production of individual workpieces of the second sheet layout. Subsequently, the production controller 102 changes the second and third sheet layouts by shifting workpieces from the second sheet layout to the third sheet layout and by shifting workpieces from the third sheet layout to the second sheet layout. In other words, the workpieces contained in the second and third sheet layouts are partially exchanged.

FIG. 9 shows the original and specified sheet layout, and FIG. 13 shows the adapted sheet layout. The two workpieces, which in the original third sheet layout are located in the bottom left and middle left, have been shifted to the top left and top middle in the adapted second sheet layout. Conversely, the four workpieces, which in the original second sheet layout are arranged in the top left, middle left, top middle and middle center, are shifted in the adapted third sheet layout to the bottom left to second-to-last top left.

FIG. 13, on the right, shows the workflows of the changed sheet layouts. The respective workflows before changing of the second and third sheet layouts are shown with dashed lines below the workflow for the second material sheet 162 and below the workflow for the third material sheet 164. Changing the second and third sheet layouts increases the duration of the production workflow 168 for the second sheet layout and shortens the duration of the production workflow 170 for the third sheet layout.

FIG. 14 shows that by changing the sheet layouts, the waiting period 138 and thus the production duration 142 for producing the plurality of workpieces on the basis of the changed sheet layout is reduced. Due to the shortened production duration 142, the production controller 102 replaces the specified sheet layouts with the changed sheet layouts.

FIGS. 15 and 16 show an adapted first sheet layout of a further exemplary embodiment and a temporal workflow for producing the plurality of workpieces on the basis of the adapted first sheet layout of FIG. 15, in which the same reference signs are used for identical and functionally equivalent elements and, in this respect, reference can be made to the above statements relating to FIGS. 8 to 11, so that substantially only the present differences are discussed.

The production sequence is adapted, instead of step d4), by step: d6) adapting the production steps of the first production process in such a way that the production steps of the first production process bring about the production of at least two adjacent workpieces in the first sheet layout with at least one connecting element for jointly depositing the adjacent workpieces. This results in the adapted first sheet layout.

In the exemplary embodiment from FIG. 15, the workpieces, which are arranged at the bottom in the adapted first sheet layout, are each connected to each other by a connecting element 186 in the form of a connecting bridge. Each connecting element 186 forms a holding point at which the adjacent workpieces are not completely separated from each other. This allows the three interconnected workpieces to be deposited together, thus reducing the duration for depositing 178.

FIG. 15, on the right, shows a workflow which the machine tool 104 carries out to produce the workpieces of the adapted first sheet layout. The workflow before carrying out step d6) is shown with dashed lines below the workflow for the adapted first sheet layout.

FIG. 16 shows that the adapted first sheet layout eliminates the waiting period 138 and thus reduces the production duration 142 for producing the plurality of workpieces on the basis of the adapted first sheet layout. Due to the shorter production duration 142, the production controller 102 replaces the first sheet layout with the adapted first sheet layout.

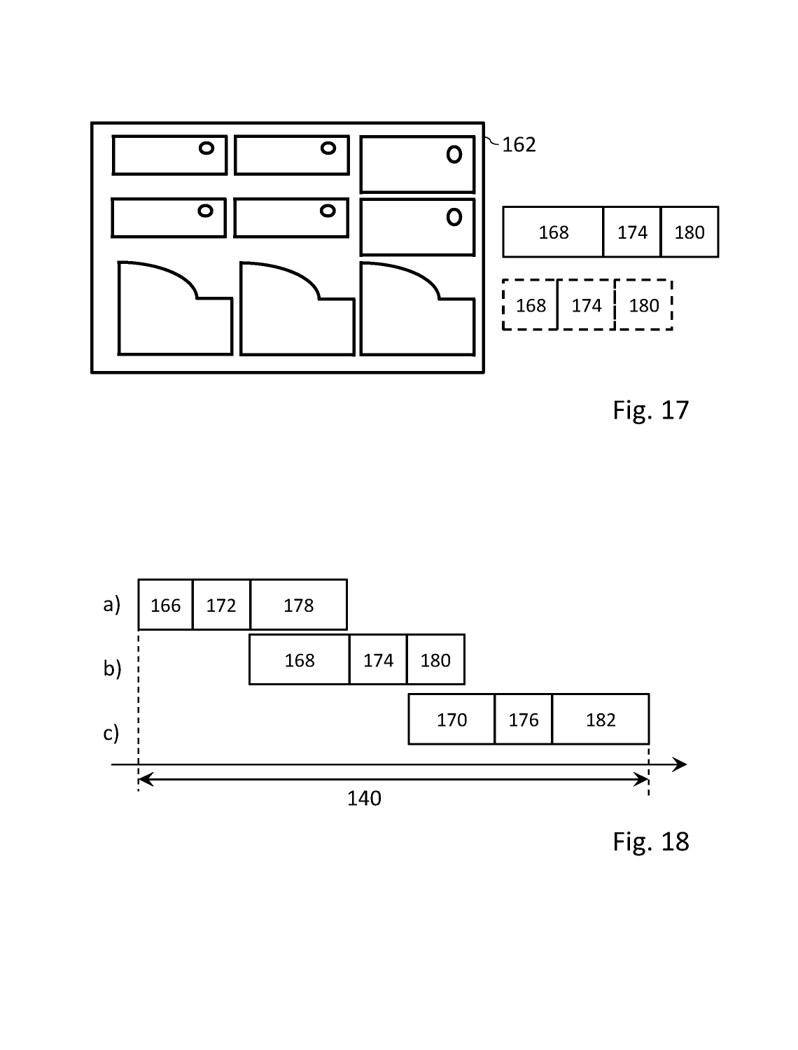

FIGS. 17 and 18 show the second sheet layout with an adapted production workflow 168 of the second sheet layout and a temporal workflow for producing the plurality of workpieces on the basis of the adapted production workflow 168 of the second sheet layout, in which the same reference signs are used for identical and functionally equivalent elements and, in this respect, reference can be made to the above statements relating to FIGS. 8 to 11, so that substantially only the present differences are discussed.

The production controller 102 carries out the method for the purpose of utilizing the waiting period 138 before production of the plurality of workpieces. This is achieved by adapting the production sequence, instead of step d4), by step: d7) changing a process parameter of at least one production step of the second production process for the purpose of increasing the process duration of the second production process.

In the exemplary embodiment shown in FIGS. 17 and 18, the process parameter is a cutting parameter for cutting out the workpieces from the second material sheet 162. The cutting parameter is changed in such a way that the duration of cutting out the workpieces is increased while the quality of the produced cut edge is improved. This increases the duration of the production workflow 168 of the second sheet layout and thus the duration of the second production process.

The process parameter of the production step in the second production process is changed in such a way that the duration of the production workflow 168 is increased by the amount of the waiting period 138. This avoids the waiting period 138.

FIG. 17, on the right, shows a workflow carried out by the machine tool 104 to produce the workpieces of the second material sheet 162. The workflow before carrying out step d7) is shown in dashed lines below the workflow for the second material sheet 162.

FIG. 18 shows that by increasing the process duration of the second production process, the waiting period 138 is eliminated. The production duration 140 remains unchanged. Increasing the process duration of the second production process reduces energy and/or achieves a higher quality of the produced workpieces.

In further exemplary embodiments, at least one of steps d5) to d8) can be carried out in addition to step d4).

In a further exemplary embodiment, a computer program comprises commands which, when the computer program is executed by a computer, cause it to carry out the method.

In a further exemplary embodiment, a data processing device is configured to carry out the method.

In a further exemplary embodiment, a machine tool is designed to carry out the method.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for producing a plurality of workpieces using a machine tool configured to produce the plurality of workpieces from a number of material sheets, the method comprising:
a) specifying a production sequence for producing the plurality of workpieces using the machine tool from the material sheets, the specified production sequence including:
a first production process having a first number of production steps for producing a first number of the plurality of workpieces,
a first sorting process comprising removing and depositing the first number of the plurality of workpieces produced by the first production process, wherein the depositing of the first number of the plurality of workpieces is configured to be carried out at least partially simultaneously with a first subsequent production process,
a second production process having a second number of production steps for producing a second number of the plurality of workpieces,
a second sorting process comprising removing and depositing the second number of the plurality of workpieces produced by the second production process, wherein the depositing of the second number of the plurality of workpieces is configured to be carried out at least partially simultaneously with a second subsequent production process,
a third production process having a third number of production steps for producing a third number of the plurality of workpieces, and
a third sorting process comprising removing and depositing the third number of the plurality of workpieces produced by the third production process, wherein the depositing of the third number of the plurality of workpieces is configured to be carried out at least partially simultaneously with a third subsequent production process,
wherein each production process which follows one of the first, second, and third sorting processes in the production sequence is carried out at least partially simultaneously with the depositing in a preceding one of the first, second, and third sorting processes in the production sequence;
b) determining a process duration for depositing the first number of the plurality of workpieces;
c) determining a process duration of the second production process;
d) based on a determination that the determined process duration of step b) is longer than the determined process duration of step c): adapting the production sequence for the purpose of reducing a production duration of the plurality of workpieces and/or for the purpose of utilizing a waiting period during which no production step of the specified production sequence can be carried out and which occurs as a result of depositing the produced first number of the plurality of workpieces; and
e) producing the plurality of workpieces by carrying out the production sequence using the machine tool.

2. The method according to claim 1,
wherein the adapting of the production sequence of step d) includes:
d1) shifting a number of production steps from the first production process and/or shifting a number of production steps from the third production process to the second production process,
wherein a value of a process duration of the number of production steps shifted in step d1) is greater than or equal to a value of a difference calculated by subtracting the process duration determined in step c) from the process duration determined in step b).

3. The method according to claim 1,
wherein the machine tool has a first removal apparatus and a second removal apparatus,
wherein the production sequence provides for the first sorting process and the second sorting process to be carried out by the first removal apparatus,
wherein the production sequence provides for the third sorting process to be carried out by the second removal apparatus,
wherein a production step of the second production process brings about a separating of the second number of the plurality of workpieces from the material sheet by the machine tool,
wherein the adapting of the production sequence of step d) includes:
d2) shifting the production step of the second production process, which brings about the separating of the second number of the plurality of workpieces from the material sheet, and the second sorting process after the third sorting process.

4. The method according to claim 1,
wherein the production steps of the first production process bring about the production of the first number of the plurality of workpieces from a first material sheet based on a first sheet layout,
wherein the removal in the first sorting process comprises removal of the first material sheet in the form of a first scrap skeleton together with the first number of the plurality of workpieces produced,
wherein the production steps of the second production process bring about the production of the second number of the plurality of workpieces from a second material sheet based on a second sheet layout,
wherein the removal of the second sorting process comprises removal of the second material sheet in the form of a second scrap skeleton together with the produced second number of the plurality of workpieces,
wherein the production steps of the third production process bring about the production of the third number of the plurality of workpieces from a third material sheet based on a third sheet layout,
wherein the removal of the third sorting process comprises removal of the third material sheet in the form of a third scrap skeleton together with the produced third number of the plurality of workpieces,
wherein the process duration of step b) additionally comprises depositing the first scrap skeleton.

5. The method according to claim 4,
wherein the adapting of the production sequence of step d) includes:
d3) shifting the first production process and the first sorting process after the second sorting process, based on a value of a determined production duration of the plurality of workpieces by the production sequence before the shifting of the first production process and the first sorting process being greater than a value of a determined production duration of the plurality of workpieces by the production sequence after the shifting of the first production process and the first sorting process; or
d4) shifting the third production process and the third sorting process after the first sorting process, based on the value of the determined production duration of the plurality of workpieces by means of the production sequence before the shifting of the first production process and the first sorting process being greater than a value of a determined production duration of the plurality of workpieces by the production sequence after the shifting of the third production process and the third sorting process.

6. The method according to claim 4,
wherein the adapting of the production sequence of step d) includes:
d5) changing the first sheet layout, the second sheet layout and/or the third sheet layout, based on a value of a determined production duration of the plurality of workpieces by the production sequence before the changing the first sheet layout, the second sheet layout and/or the third sheet layout being greater than a value of a determined production duration of the plurality of workpieces by the production sequence after the changing of the first sheet layout, the second sheet layout and/or the third sheet layout.

7. The method according to claim 4,
wherein the adapting of the production sequence of step d) includes:
d6) adapting the production steps of the first production process such that the production steps of the first production process bring about a production of at least two adjacent workpieces in the first sheet layout with at least one nanojoint and/or microjoint configured for jointly depositing the adjacent workpieces.

8. The method according to claim 1,
wherein the adapting of the production sequence of step d) includes:
d7) changing a process parameter of at least one production step of the second production process to increase the process duration of the second production process.

9. The method according to claim 1,
wherein the adapting of the production sequence of step d) includes:
d8) inserting an energy-saving process before or after the second production process to bring about an energy-saving mode of at least one device of the machine tool that is not required for depositing the first number of the plurality of workpieces,
wherein the process duration of the energy-saving process is equal to a difference calculated by subtracting the process duration determined in step c) from the process duration determined in step b).

10. A non-transitory computer-readable medium having processor-executable instructions stored thereon, wherein the processor-executable instructions, when executed by one or more processors, facilitate performance of the method of claim 1.

11. A data processing device configured to carry out the method according to claim 1.

12. A machine tool
configured to carry out the method according to claim 1.

13. A production system, comprising:
a production controller configured to carry out the method according to claim 1; and
a machine tool configured to produce a plurality of workpieces from the number of material sheets.
